(19) United States
(12) Patent Application Publication
(10) Pub. No.: US 2014/0154602 A1
(43) Pub. Date: Jun. 5, 2014

(54) ELECTRIC STORAGE DEVICE

(71) Applicant: Martin Michelitsch, Kumberg (AT)

(72) Inventor: Martin Michelitsch, Kumberg (AT)

(21) Appl. No.: 14/129,975

(22) PCT Filed: Jun. 26, 2012
(86) PCT No.: PCT/EP2012/062309

§ 371 Date: Feb. 18, 2014

(30) Foreign Application Priority Data
Jun. 30, 2011 (AT) A 956/2011

(51) Int. Cl. H01M 2/20; H01M 8/02

(52) U.S. Cl. CPC H01M 2/202; H01M 8/0297
USPC 429/432; 429/158; 429/91; 429/100; 429/468

(57) ABSTRACT

An electric storage device, secondary battery and high-voltage battery, for an electric vehicle, including at least one stack of storage cells that are strung together. At least two cell poles of adjacent storage cells are connected to one another by at least one cell connector in an electrically conductive manner. The connection between at least one cell pole and the cell connector and/or between at least one cell pole and at least one busbar and/or directly between two cell poles is formed by at least one cold surface-pressed clinch joining connection.

### CROSS-REFERENCE TO RELATED APPLICATIONS

The present application is a National Stage Application of PCT International Application No. PCT/EP2012/062309 (filed on Jun. 26, 2012), under 35 U.S.C. §371, which claims priority to Austrian Patent Application No. A 956/2011 (filed on Jun. 30, 2011), which are each hereby incorporated by reference in their respective entireties.

### TECHNICAL FIELD

Embodiments relate to an electric storage device, in particular, a secondary battery, especially a high-voltage battery, preferably for an electric vehicle, comprising at least one stack of storage cells that are strung together, wherein at least two cell poles of adjacent storage cells are connected to one another, preferably by at least one cell connector, in an electrically conductive manner, wherein the connection between at least one cell pole and the cell connector and/or between at least one cell pole and at least one busbar and/or directly between two cell poles is formed by at least one preferably cold surface-pressed clinch-joining connection.

### BACKGROUND

High-voltage batteries usually comprise battery packs with storage cells such as lithium-ion storage cells that are strung together, wherein the cell poles are electrically connected to each other by cell connectors which are connected to the cell poles by laser welded joints. The two cell poles of each battery cell mostly consist of different materials due to the electrochemical material properties, which raise problems for the connection techniques. In the frequently used laser welding process, the cell pole laminations which usually protrude from the cell chemistry (mostly Cu and Al) are usually welded together with an additional bimetal cell connector (e.g. aluminum sheet or copper sheet via a compacting process). Direct welding of two different materials is technically exceptionally complicated and causes additional problems to the complex laser welding process that needs to be monitored with a large amount of effort anyway.

German Patent Publication No. DE 10 2009 035 463 A1 discloses a storage device with a plurality of flat, substantially plate-shaped individual battery cells. The individual battery cells are stacked into a cell stack and enclosed by a battery housing. The individual battery cells are formed in flat frame design with metallic plates and a frame made of an insulating material.

A battery module with a plurality of plate-shaped storage cells which are strung together into a stack is also known from WO 2008/048751 A2, which cells are housed in a housing.

WO 2010/053689 A2 discloses a battery arrangement with a housing and a plurality of lithium-ion cells which are arranged adjacent to one another. A thermally conductive, electrically insulating fluid flows through the housing for cooling purposes.

A storage device with adjacently arranged stacks of storage cells is known from WO 2010/067944 A1, wherein the storage cells are cooled by cooling air.

German Patent Publication No. DE 27 05 050 A1 discloses a battery configuration with at least one galvanic cell which comprises a positive and a negative battery connection and a positive and a negative electrode material which is wound in a spiral manner into a cylindrical shape, wherein the connection between the electrode material with the poles occurs via a mechanical point-contact connection.

A prismatic storage battery with several cell vessels is known from German Patent Publication No. DE 10 2004 003 066 A1, wherein a stack of plates is accommodated in each cell vessel. Contact connecting plates respectively extend along the intermediate walls of the cell vessel between the stacks of plates, wherein the contact connecting plates which are opposite of one another on an intermediate wall connect each other through the intermediate wall in a conductive manner and the contacts of the stacks of plates with the associated contact connecting plates are connected in an electrically conductive manner by welding. The connection of contact connecting plates through the intermediate wall is arranged as a cold-pressed clinch-joining connection.

WO 2011/144372 A1 discloses a lithium-ion battery cell and a method for producing an electrically conductive contact of terminals of battery cells, wherein the terminals are connected to each other in an electrically conductive manner by a joining method such as a clinch joining method.

A method for connecting a battery pole of a first battery cell to a battery pole of a second battery cell is known from German Patent Publication No. DE 10 2009 046 505 A1, wherein the battery poles are connected for producing the electrically conductive contact in a positive and non-positive manner by means of clinch-joining, which is also known as pressurized clinching, or clinching or tox clinching.

### SUMMARY

It is the object of embodiments to avoid these disadvantages and to simplify the production of a rechargeable electric storage device of the kind mentioned above.

This is achieved in accordance with the invention in such a way that at least one cell connector has a U profile or a Y profile.

The connection between at least one cell pole and at least one cell connector and/or between at least one cell pole and at least one busbar and/or directly between two cell poles is formed by at least one clinch joining connection that is cold-pressed for example, wherein preferably each clinch joining connection comprises several adjacently arranged joints. The joints can be arranged in several parallel rows, wherein the joints of at least two adjacently arranged rows can be arranged offset with respect to each other. The joints can have a round outline (e.g. circular or oval) or an angular outline (e.g. rectangular or triangular). In the case of a round outline without a cutting portion, a triaxial deformation state and therefore tearing of the material can be prevented. Furthermore, a round outline without sharp edges is better for the coating in comparison to an angular outline and more corrosion-proof as a result of improved water and gas tightness, which is especially important for the electric connection. The gas tightness is especially relevant in the case of electric connections in order to improve resistance against ageing and corrosion.

Furthermore, at least one joint can be provided with a structure. The strain on the material can be minimized through the choice of the structure, the shape and/or the arrangement of the joints. For example, the joints can be arranged in a 2×4 matrix arrangement. The clinch-joining connection can be performed in the cold or warm or heated state. In order to save parts it can be provided that at least one cell connector is formed by the cell poles of mutually connected cell poles.

Special advantages are obtained however when at least one cell connector is formed by a cell connector element which is different from the cell poles. Additional surfaces are produced by the separate cell connector elements, which can improve the heat exchange. In particular, when the cell connector element comprises a U profile or a Y profile with partly parallel legs, the mechanical loading of the storage cell can be kept very low because the upwardly protruding parallel lugs of the cell poles need not be bent over. The parallel aligned lugs of the cell poles maintain the same length during the entire joining process, as a result of which more than two cell poles can be connected to each other (e.g. with several cell connector elements with a U profile and/or a Y profile) without having to bring the lugs subsequently to the same length. Furthermore, the clinching tool can act normally on the parts to be clinch-joined during the clinch joining process, as a result of which no shearing forces are introduced into the storage cells.

It is provided in a preferred embodiment that cell connectors with a U profile and Y profile are arranged in an alternating fashion between successive storage cells. Parallel switching of storage cells is possible with U-shaped cell connectors (busbar), wherein two homopolar cell taps of two storage cells are connected via a busbar (U-shaped busbar) with two further storage cells to the respective opposite pole. Parallel switching of the storage cells is also possible directly by the respective opposite poles, wherein homopolar cell poles of two storage cells are connected to further two storage cells of the respective opposite pole (e.g. 1S2P: 1x serial, 2x parallel). The tapping of the cell voltage via cell voltage plates can additionally be used as measurement tapping for the cell voltage measurement.

It is provided in an especially preferred embodiment that at least two cell poles of adjacent storage cells are directly connected to each other by at least one clinch joining connection and form a preferably Y-shaped cell connector.

The clinch joining connection is sealed in a gas-tight manner, thus producing a corrosion-proof long-term connection. At least one cell pole can comprise an electroplating layer, preferably a nickel coating. One advantage of clinch joining connections is that they are insensitive to the electroplating of the used materials.

In clinch joining (pressurized clinching, clinching, tox clinching), two or more sheets are plastically intrinsically deformed via a male die and a female die, thus producing an interlocked connection between the sheets. During the connection of cell sheets, they are joined to each other in one work process depending on the chosen type of switching (e.g., two sheets in a series connection or three or four sheets in a parallel connection of two respective storage cells with cell connectors and cell voltage monitoring cables), wherein several joints (clinching points) can be placed by using multiple tools at the same time on a cell pole packet (cell pole stack) or several cell pole packets.

During clinch joining of materials, the harder material should always be aligned on the male die side and the soft material on the female die side of the clinch joining tool. The softer material can be deformed to a higher extent, so that good deformation can occur in the outer region of the joint and a strong connection is produced. The multiple joints enable a high current carrying capability. The clinch joining connection allows the cell poles to make a simple contact with different materials (e.g. copper to aluminum or vice versa) without requiring additional components. Furthermore, the connection of and to non-metallic materials with conductive alloys is possible.

At least one cell pole can be connected to at least one voltage tapping element, preferably by means of a clinch joining connection. For example, for the purpose of tapping the voltage a voltage tapping element which is arranged as a platelet and which carries at least one table for the cell voltage tapping can be co-clinched. Furthermore, the connections for a monitoring unit and/or thermal sensors or the like can also be co-clinched. The busbar can simultaneously act as a cell voltage tapping platelet.

Since the position of the joints is allowed to scatter to a much higher extent than the component positioning in a laser welding connection for example, a high tolerance compensation level is achieved. Cell poles and storage cells, especially sealing seam cells such as pouch cells, need not be produced in a narrow tolerance band.

At least two cell poles can have different thicknesses, wherein preferably at least one cell pole can consist of several mutually connected cell pole layers.

A simple and cost-effective production by simultaneous clinching of several joints can be achieved by using parallel multiple tools, especially for large piece numbers, wherein it is only necessary to check very few influencing variables that are easy to control such as material wall thickness, pressing force or the like. Furthermore, at least one deformation and/or cutting process (cutting to size, bending or the like) can further be performed simultaneously during the clinch joining process.

In order to prevent short-circuits or current losses during the joining process, an electrically non-conductive joining tool should be used especially in the case of parallel joining processes.

One big advantage of clinch joining connections is that the joints can be checked visually. It is a further advantage over thermal joining methods such as welding or soldering processes that no heat is introduced into the storage cells. The introduction of forces into the storage cells is also prevented.

It is especially advantageous if at least one clinch joining connection is arranged in a cooling air channel, wherein preferably the clinch joining connection comprises at least one joint protruding into the cooling air flow of the cooling air channel. The protruding joints lead to an increase of the surface which is relevant for the cooling, e.g. in the case of direct air cooling of the cell poles. The protruding joints additionally act in a turbulence-increasing way, which advantageously has an effect on the heat transport during air cooling. The volumetric energy density of the storage device can thus be increased by efficient utilization of the components. The cooling effect can be optimized by choosing the structure, the shape and/or the arrangement of the joints and the joining direction.

It may be advantageous in some installation situations to place U-shaped cell connectors with downwardly opened legs on the cell poles, so that the region spanning the cell poles is spaced further away from the storage cells than the legs. The region spanning the two cell poles would prevent clinching from above. In order to still enable the use of a clinching tool, it is advantageous if the U-shaped cell connector comprises at least one mounting opening in a region spanning at least two cell poles, wherein preferably the clinch joining connection is arranged between the mounting opening and the storage cell. The clinching tongs can be introduced from above through the mounting opening and the necessary clinching points of the clinch joining connection can be placed.

The invention is suitable for primary batteries, secondary batteries, fuel cells and capacitors, and combinations thereof.

### DRAWINGS

Embodiments will be explained below by reference to the drawings, wherein:

FIG. 1 illustrates a storage device in accordance with embodiments in an oblique view from above.

FIG. 2 illustrates the storage device in a sectional view along the line II-II in FIG. 1.

FIG. 3 illustrates the storage device in a front view.

FIG. 4 illustrates the storage device in an oblique view from below.

FIG. 5 illustrates a storage device module of the storage device in an oblique view.

FIG. 6 illustrates this storage device module in a view from below.

FIG. 7 illustrates a stack of storage cells in an oblique view.

FIG. 8 illustrates this stack in a side view.

FIG. 9 illustrates the stack of storage cells of a storage device module in an oblique view.

FIG. 10 illustrates a stack of storage cells in a sectional view along the line X-X in FIG. 9.

FIG. 11 illustrates a detail of this stack in a sectional view analogously to FIG. 10.

FIG. 12 to FIG. 14 illustrate details of a stack in different embodiments in oblique views.

FIG. 15 illustrates a stack in a further embodiment in an oblique view.

FIG. 16 illustrates a detail of a stack in a further embodiment in an oblique view.

FIG. 17 illustrates a stack in a further embodiment in an oblique view.

FIG. 18 illustrates a detail of this stack.

FIG. 19 illustrates a clinch joining connection in an oblique view.

FIG. 20 illustrates a joint of a clinch joining connection in a first embodiment.

FIG. 21 illustrates a joint of a clinch joining connection in a second embodiment.

FIG. 22 illustrates the joint of FIG. 20 in detail in a sectional view.

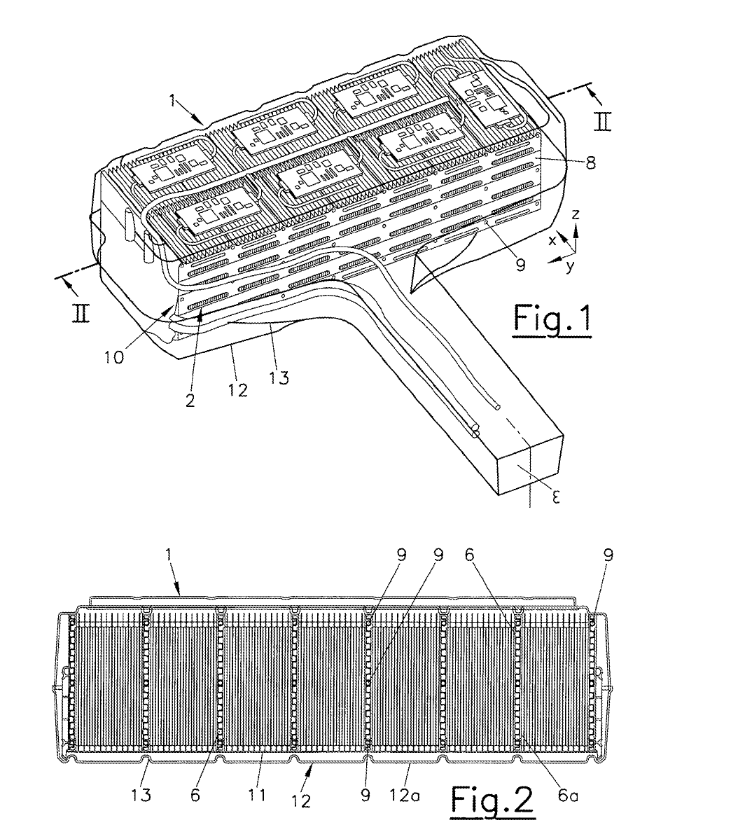

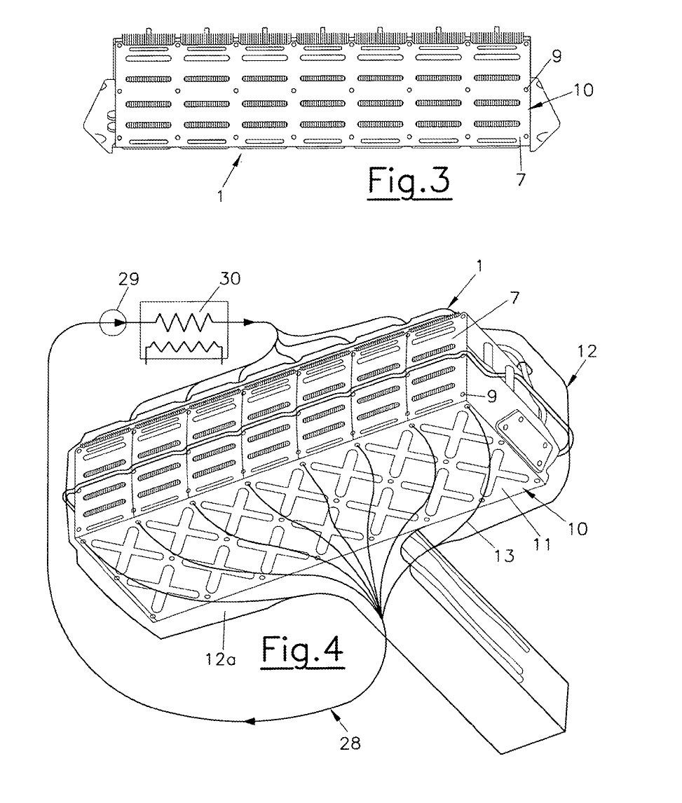

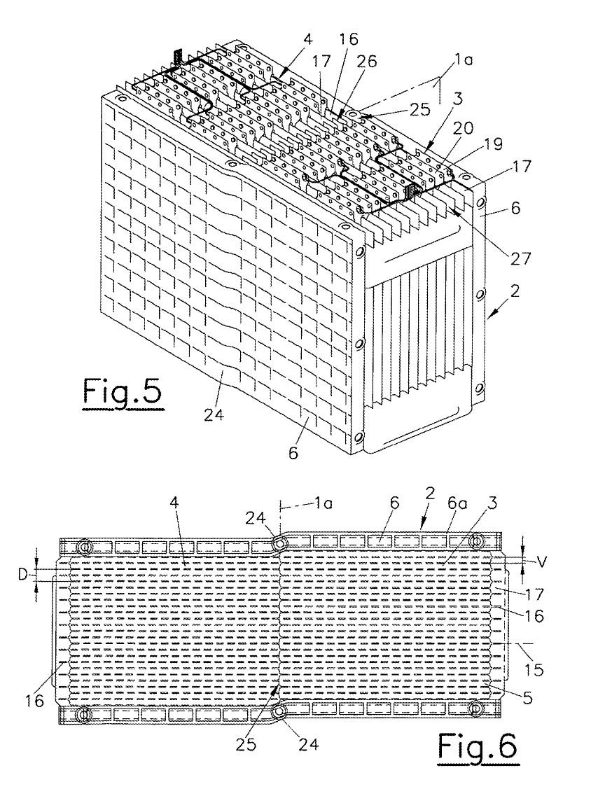

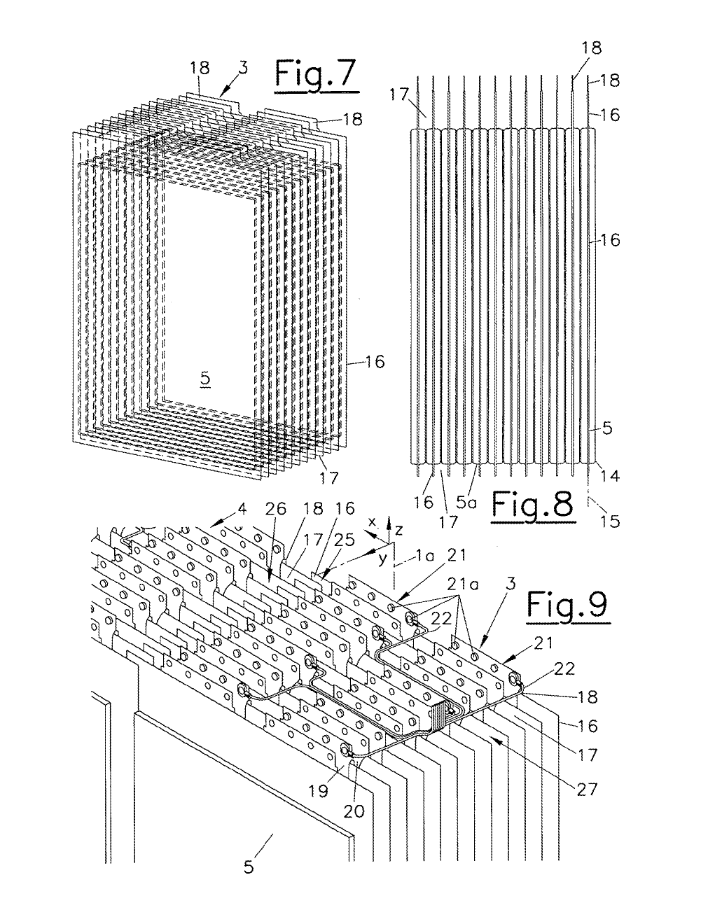

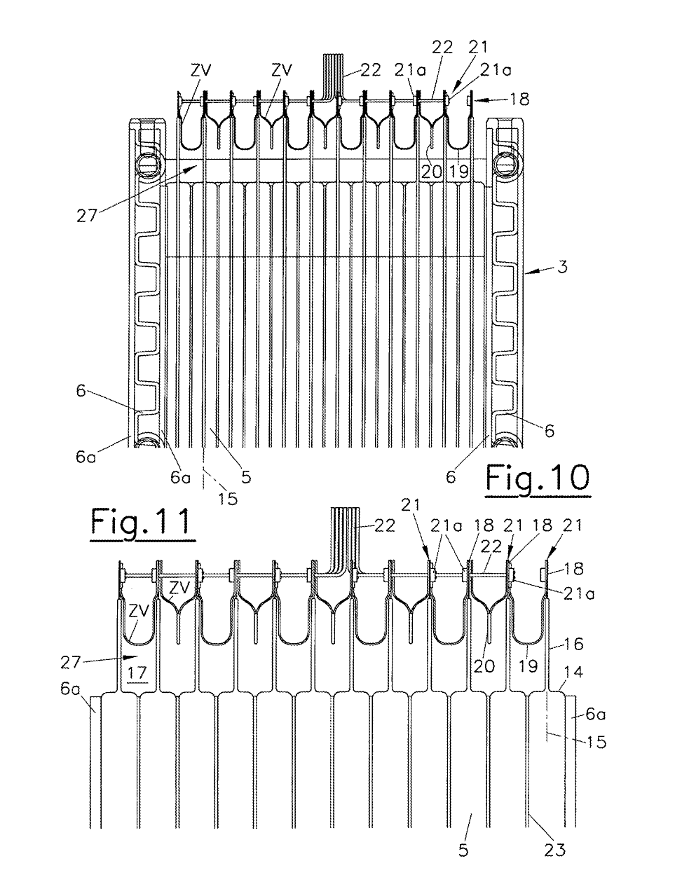

### DESCRIPTION

The storage device 1, which is formed by a secondary battery, for example, comprises a plurality, such as, for example seven, storage device modules 2 in accordance with embodiments. Each storage device module 2 comprises two stacks 3, 4 of clamped storage cells 5 which are arranged next to one another.

The stacks 3, 4 of each storage device module 2 are arranged between two structurally stiff, corrugated plates 6 made of metal such as aluminum or plastic, wherein the plates 6 can be formed by die-cast parts. The plates 6 themselves are clamped between two holding plate 7, 8 on the front and rear side of the storage device 1, wherein the holding plate 7 on the front side is tightly connected via a clamping screws 9 to the holding plate 8 on the rear side. The clamping screws 9 are respectively arranged in the region of the plates 6. The plates 6 form a holding frame 10 for the storage device modules 2 together with the holding plates 7, 8.

The holding plates 7, 8 comprise openings in order to keep the weight as low as possible. As seen in the stacking direction y, the defined distance between the clamping screws 9 ensures that the storage cells 5 are installed with correct positioning and with a specific pretensioning which remains substantially unchanged over the operational lifespan of the storage device 1. A respective elastic insulating layer 6a, which is made of a foamed material, is arranged between the plates 6 and the adjacent storage cells 5, which layer allows an even and careful distribution of pressure.

The storage device 1 is sealed off at the bottom by a base plate 11. The storage device 1 plus the holding frame 10 is arranged in a housing 12, wherein cooling-air flow paths are arranged between the housing 12 and the storage device 1. Flow guide areas 13 are incorporated in the housing base 12a for guiding-air flow, as shown in FIG. 2 and FIG. 4.

Each storage cell 5 is enclosed by a plastic cover 14, wherein the plastic cover 14 comprises a protruding sealing seam 16 along the narrow side 5a for sealing approximately in the region of a central plane 15 of the cell. One respective cavity 17 is opened up between the sealing seams 16 of two adjacent storage cells 5.

In order to save space, the two adjacently arranged stacks 3, 4 of each storage device module 2 are arranged in an offset and overlapping manner with respect to each other. The offset V is approximately half the thickness D of a storage cell 5. The sealing seams 16 of a storage cell 5 of the one stack 3, 4 protrude into a cavity 17 which is opened up by the sealing seams 16 of two adjacent storage cells 5 of the other stack 4, 3. As a result, the cavity 17 can be utilized at least partly by housing a part of the sealing seams 16. This has a highly advantageous effect on the size of the built-in space and the volumetric energy density. The offset V between the two stacks 3, 4 ensures that the plates 6 form a step 24 in the region of a longitudinal central plane 1a of the storage device 1.

Cell poles 18 protrude on the upper narrow side 5a from the plastic covers 14, which cell poles are connected to each other via U-shaped and Y-shaped cell connectors 19, 20. The connection between the cell connectors 19, 20, which are formed for example by separate cell connector elements ZV, and the cell poles 18 can be arranged as a clinch joining connection 21 in a clinch joining process, which clinch-joining connection comprises one or several joints 21a. This allows an especially high current carrying capability by adjacently arranged multiple joints and a corrosion-proof long-term connection on the basis of the joints which are sealed in an air-tight manner and simple contacting of the cell poles 18 with different materials (copper to aluminum and vice versa), without additional components. Two to four sheets can be connected electrically to each other by means of the clinch joining process, wherein the materials of copper, aluminum and steel are especially suitable at wall thicknesses of 0.1 mm to 0.5 mm. Cell voltage monitoring cables 22 can optionally be linked to the cell poles 18 in a clinch joining process in one work step simultaneously with the cell connectors 19, 20, e.g. by means of cell voltage platelets on which a cable is provided. The same tool can be used for the same total thicknesses. Since the position of the joints 21a of the clinch joining connection 21 is allowed to scatter more than a laser welded connection for example, a relatively high tolerance compensation level is obtained. Simple and cost-effective production can be realized for large piece numbers by using parallel and multiple tools, wherein there are only a few influential variables such as material wall thickness, pressing force etc which are easy to manage. As a result of the joints 21a which protrude into the cooling-air channel 27, the heat-dissipating surface of the storage device 1 is increased, which is especially relevant in direct air cooling of the cell poles 18. The protruding joints 21a also contribute to the increase in turbulence, which especially improves heat transport during the air cooling. The joints 21a also contribute to increasing the volumetric energy density by efficient utilization of the overall space as a result of their positive effect on cooling.

In order to achieve especially good volumetric energy density, it is necessary to position the storage cells 5 as close as possible to each other. For this purpose, the thinnest possible thermal and electric insulating layer 23 in form of an installation foil for example is arranged between the storage cells 5 in order to prevent the occurrence of a domino effect during thermal overload of an adjacent storage cell 5.

The cavities 17 simultaneously form the cooling-air channels 26, 27. The cavities 17 form first cooling-air channels 26 in the region of the overlap 25 of the two stacks 3, 4, i.e. in the region of the longitudinal central plane 1a of the storage device 1, which cooling-air channels are arranged in the direction of the vertical axis z of the storage device 1. The sealing seams 16 form flow guide surfaces for the air flow and heat-dissipating surfaces. Second cooling-air channels 27 are formed in the region of the cell poles 18 by the cavities 17 on the upper side of the storage cells 5 in the direction of a transverse axis x normally to the vertical axis z and normally to the stacking direction y.

The first and second cooling-air channels 26, 27 are part of a closed cooling-air circuit 28 for cooling the storage device 1, wherein the cooling-air circuit 28 comprises at least one cooling-air fan 29 and at least one heat exchanger 30. Arriving from the cooling-air fan 29 and the heat exchanger 30, the cooling air is supplied to the housing 12 in the region of the holding plate 9 on the rear side and/or the upper side of the storage device 1 or in the region of the cell poles 18. The cooling-air flow flows through the second cooling-air channels 27 and cools the cell poles 18 and the cell connectors 19, 20. At least a portion of the cooling air subsequently reaches the first cooling-air channels 26, which guide the cooling air downwardly against the vertical axis z. The flow passes through all intermediate spaces and cavities 17 and the occurring heat is removed. The remaining cooling air also flows between the holding plate 8 on the front side of the storage device 1 and the housing 12 to the housing base 12a of the housing 12, where it is guided by the flow guide surfaces 13 to the longitudinal central plane 8 of the vehicle and is collected there. The cooling air is then aspirated by the cooling-air fan and is cooled in the heat exchanger 30, before it is supplied to the storage device 1 in the closed cooling circuit 28 again.

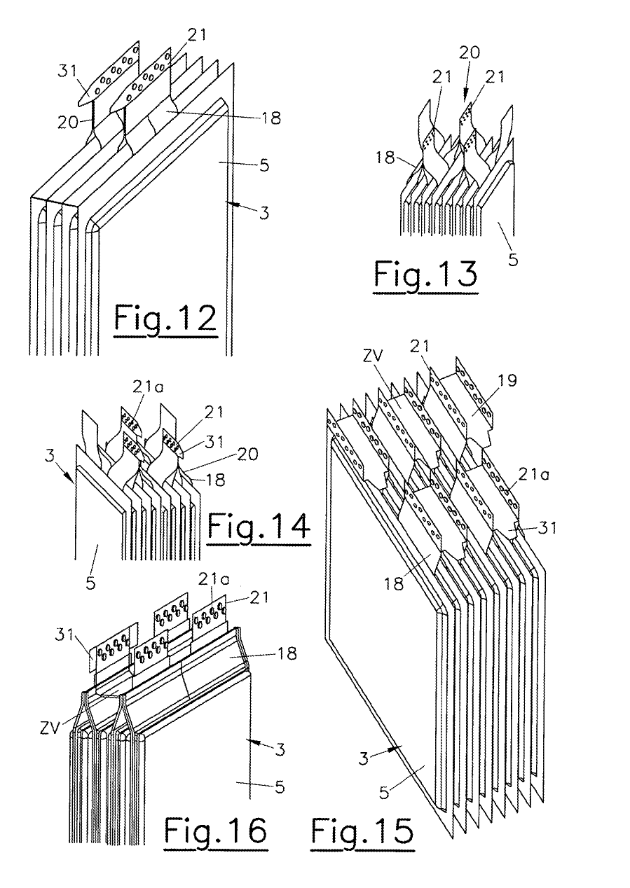

FIG. 12 illustrates a sectional view of a stack 3, wherein the cell poles (cell taps) 18 of two adjacent storage cells 20, which cell poles assume the function of the cell connectors 20, are electrically serially connected to each other. The cell connectors 20 are formed by the cell poles 18 themselves which are bent together in a Y-shaped away and are connected to each other by a clinch joining connection 21. The two cell poles 18 are clinched together with a platelet-shaped voltage tapping element 31. A cell pole 18 or cell arrester is connected to the opposite pole of the adjacent storage cell 5.

FIGS. 13 and 14 illustrate embodiments with a respective parallel connection of storage cells 5, wherein two homopolar cell poles 18 can be connected together with two further storage cells 5 to an opposite pole and a voltage tapping element 31.

FIGS. 15 and 16 illustrate a further embodiment of a stack 3 of storage cells 5, wherein the storage cells 5 are connected to each other by U-shaped cell connectors 19 or busbars. Homopolar cell poles 18 of two storage cells 5 are connected via a U-shaped cell connector 19 (busbar) to two further storage cells 5 with opposite pole. The busbar can simultaneously be used as a voltage tapping element.

As illustrated in FIG. 15, a U-shaped cell connector can also offer the possibility of linking cell monitoring measuring lines. In FIG. 15, a voltage tapping element 31 is shown as a tab provided on the U-profile for tab connectors with cables 22. As an alternative to a plug-in connection, it is also possible to provide soldering with the line. Furthermore, a connection on the tab can be produced by resistance welding, ultrasonic compact welding or via a screwed joint on the tab. The cell monitoring measuring lines are guided in current energy storage units with lithium cells from each storage cell 5 to a monitoring unit. This monitoring unit measures the individual cell voltages. In most cases it is also capable of balancing cell voltage imbalances.

FIG. 16 illustrates a further possibility for connecting the cell monitoring measuring lines by means of co-clinched voltage tapping elements 31.

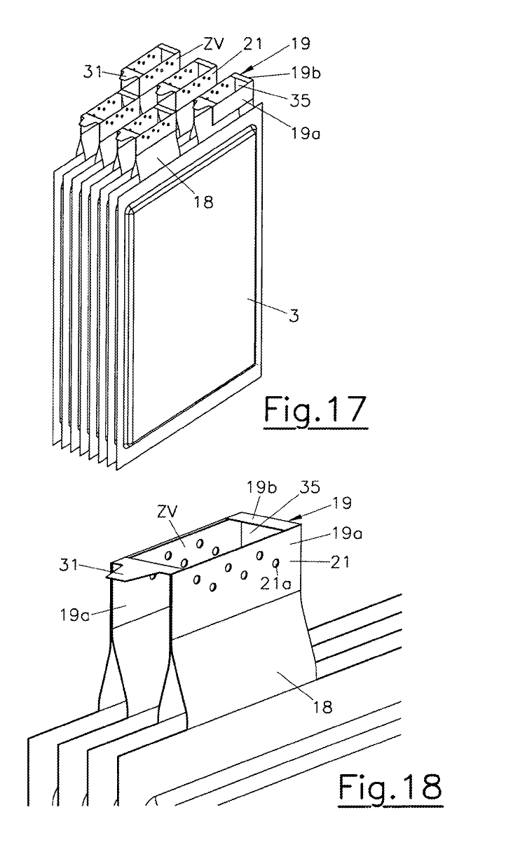

FIGS. 17 and 18 illustrate an embodiment with U-shaped cell connectors 19 which are placed in reverse order on the cell poles 18, i.e. with legs 19a which are opened downwardly. In order to enable the application of a clinching tool to the cell poles 18, mounting openings 35 are provided in the belt region 19b of the U-shaped cell connectors 19 which span the cell poles 18, which mounting openings are used for introducing the clinching tongs and thus performing the clinch-joining connection 21.

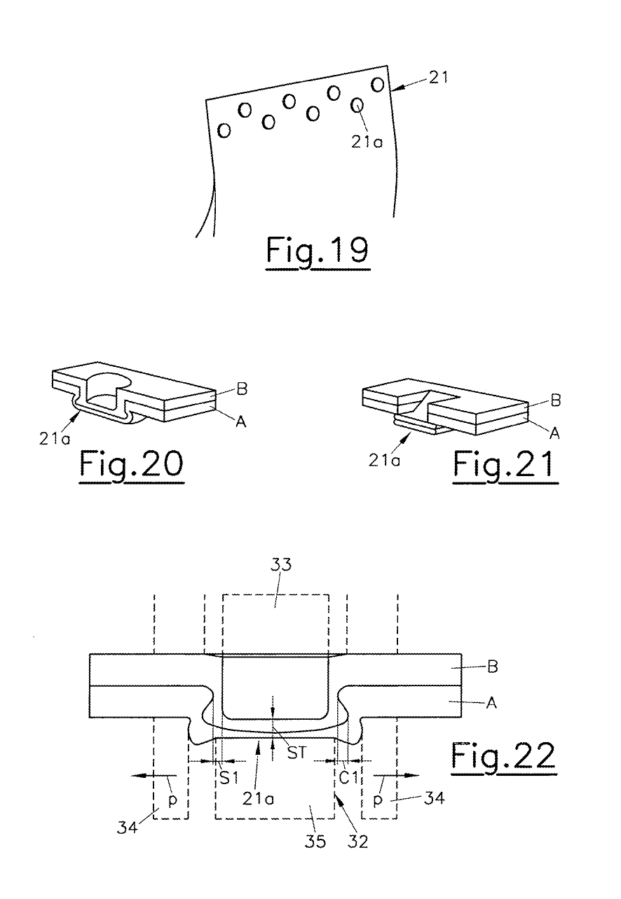

FIG. 19 illustrate a clinch-joining connection 21 with two offset rows of circular joint 21a. The minimum requirements for sufficient current monitoring with minimal heat loss are four joints 21a in this example. Eight joints 21a which are offset in two rows are arranged for sufficient mechanical stability and for improving the transfer resistance. A peeling strain, which may act from below in FIG. 19, is intercepted by the bottom row, so that the second row is not subject to any mechanical stresses and the electrical conductivity is therefore also not impaired.

FIG. 20 illustrates an example of a clinch joining connection 21 with a substantially circular layout. In FIG. 21 on the other hand a clinch joining connection 21 with a rectangular layout is shown. A round layout for the clinch joining connection 21 for use as an electric connection is preferred due to corrosion resistance, water and gas tightness, and also the property of an arrangement which protects the coating, and a relatively large surface connection of the material which is obtained by the shaping.

The process or method of single-step clinching with opening female die 32 may include the following (see FIG. 22).

In the first part of the method, the overlapping sheets A, B are plastically deformed by a male die 33 and pressed into a female die cavity. The female die wall 34, which is usually divided into two or four parts, remains closed.

Once the bottom sheet A has reached the anvil 35, i.e. the base of the female die cavity, the material will flow laterally and form a mushroom-shaped joint 21a. In this phase, the female die walls 34 are pressed outwardly in a sliding fashion on a base plate (not shown in closer detail) according to the arrows P. After the retraction of the male die 33 and the removal of the workpiece, the female die walls 34 are closed again, wherein they are compressed by spring force.

This process produces an undercut C1 (see FIG. 22) of the joined materials. The undercut C1, the throat width S1, the remaining base thickness ST are features of the quality of the connection. The result of the clinch joining process is a visually appealing, extremely sturdy and reproducible connection.

In order to achieve a good clinch joining connection 21, the harder material B should always be aligned to the male die side and the soft material A on the side of the anvil 35 of the female die 32. The softer material A can be deformed to a high extent, so that good deformation of the outwardly disposed “base” can occur and a sturdy clinch joining connection 21 is produced.

Embodiments are described on the basis of a storage device 1 formed by a secondary battery. The storage device 1 can also be formed by a primary battery, a fuel cell or a capacitor.

1-22. (canceled)

23. An electric storage device, comprising:
at least one stack of storage cells that are strung together,
at least one cell connector, having a U-shaped or Y-shaped cross-section, to connect at least two cell poles of adjacent storage cells to one another in an electrically conductive manner,
wherein a connection between at least one cell pole and the at least one cell connector is formed by at least one cold surface-pressed clinch-joining connection.

24. The electric storage device of claim 23, wherein the clinch-joining connection comprises a plurality of adjacently arranged joining points.

25. The electric storage device of claim 24, wherein the joining points are arranged in a plurality of rows spatially arranged, in an offset manner with respect to each other, one above the other.

26. The electric storage device of claim 23, wherein at least one joint of the clinch-joining connection has a circular, oval, rectangular or triangular cross-section.

27. The electric storage device of claim 23, wherein at least one clinch-joining connection is sealed in a gas-tight manner.

28. The electric storage device of claim 23, wherein at least one cell pole and at least one cell connector which is connected to the cell pole by way of the clinch-joining connection is composed of at least one metallic material.

29. The electric storage device of claim 23, wherein the at least one cell connector is composed of two different metallic materials.

30. The electric storage device of claim 23, wherein the at least one cell connector is arranged in an alternating fashion between successive storage cells.

31. The electric storage device of claim 23, further comprising a cooling-air channel in which is arranged at least one clinch-joining connection.

32. The electric storage device of claim 31, wherein the at least one clinch-joining connection comprises at least one joint protruding into a cooling-air flow of the cooling-air channel.

33. The electric storage device of claim 32, wherein at least one joint of the at least one clinch-joining connection is arranged to produce turbulences in the cooling-air channel.

34. The electric storage device of claim 23, further comprising at least one cell voltage monitoring cable with at least one cell pole connected in an electrically conductive manner by way of the clinch-joining connection.

35. The electric storage device of claim 23, wherein the electric storage device is one of an electric primary battery, a secondary battery, a capacitor or a fuel cell.

36. The electric storage device of claim 23, wherein at least one storage cell is formed by a pouch cell.

37. The electric storage device of claim 23, wherein:
at least two cell poles have different thicknesses; and
at least one cell pole has a plurality of cell pole layers which are connected to each other.

38. The electric storage device of claim 23, wherein at least one cell pole has an electroplating layer.

39. The electric storage device of claim 23, further comprising at least one voltage tapping element connected to at least one cell pole by way of a second clinch-joining connection.

40. The electric storage device of claim 39, wherein the at least one voltage tapping element extends over an entire region of the second clinch-joining connection.

41. The electric storage device of claim 23, wherein at least one cell connector comprises at least one mounting opening in a belt region spanning at least two cell poles.

42. The electric storage device of claim 41, wherein the clinch-joining connection is arranged between the at least one mounting opening and the storage cell.
